(19) United States
(12) Patent Application Publication
(10) Pub. No.: US 2017/0293022 A1
(43) Pub. Date: Oct. 12, 2017

(54) INTEGRATED ANTENNA DEVICE

(71) Applicant: THALES, COURBEVOIE (FR)

(72) Inventors: Daniel ANDREIS, Valbonne (FR); Jean-Philippe GOUDEAU, Valbonne (FR); Hervé THOMAS, Valbonne (FR)

(21) Appl. No.: 15/514,380

(22) PCT Filed: Sep. 25, 2015
(86) PCT No.: PCT/EP2015/072130

§ 371 Date: Mar. 24, 2017

(30) Foreign Application Priority Data
Sep. 26, 2014 (FR) 1402169

(51) Int. Cl. G01S 7/521; G10K 11/00; B63B 49/00; G10K 11/32

(52) U.S. Cl. CPC G01S 7/521; G10K 11/32; G10K 11/006; B63B 49/00

(57) ABSTRACT

An integrated antenna device comprises a protective casing of hydrodynamic shape delimiting an inner cavity and an upper fixing interface suitable for being fixed mechanically on a carrier structure, the device further comprises an antenna housed inside the inner cavity and fixed to the internal wall of the casing at the level of at least one fixing point, an assembly of cables comprising power supply and signals reception cables linked to the antenna. The protective casing is closed in a hermetic manner and traversed in a leaktight manner by the cables.

### FIELD OF THE INVENTION

The invention generally relates to antennas, and in particular to an integrated antenna device.

### PRIOR ART

Naval vessels (for example surface boats) are generally equipped with sonar antennas fixed under their hulls, to detect and/or pinpoint objects under the water. A sonar antenna comprises an acoustic base consisting of an assembly of stacked transducers ensuring the reception and/or emission of acoustic signals and mounted on a support.

Such sonar antennas are generally placed in a leaktight dome to mechanically protect the antennas in particular from shocks, loads due to the flow of the water, cavitation effects, corrosion, etc. The dome is generally filled with an acoustically matched liquid.

Sonar antennas are optionally suspended from the hull at the level of the support of the transducers so as to damp the fast movements of the surface vessel, while the protective dome is also fixed to the surface vessel in a rigid manner, for example bolting. Such mounting must be carried out in dry dock to guarantee the leaktightness of the naval vessel and of the dome. Moreover, it requires that the sonar antenna be mounted before the dome, so as to be able to suspend the antenna and then rigidly fix the dome to the hull.

FIG. 1 schematically represents a surface vessel 1 on which a sonar antenna 2 and its protective dome 20 are mounted. The constructors of surface vessels must provide in the surface vessel construction phase a passage 21 so as to be able to raise up the power supply and signals reception cables 22 of the sonar antenna and ensure the leaktightness of the surface vessel and of the dome after mounting the sonar antenna and the dome on the hull of the surface vessel 1. The assembly of cables 22 ensuring power supply of the antenna and signals reception is raised up toward the platform of the surface vessel which is above the water line, through the passage 21.

The sonar antenna 2 and the protective dome 20 are initially brought separately into the vicinity of the lower aperture 210 of the passage 21 so as to be mounted successively on the hull of the surface vessel. The mounting of the antenna and of the dome requires several leaktightness elements which are also used to ensure the leaktightness of the assembly (surface vessel, antenna, dome) on at least two levels, including:
a first leaktightness plate 23 mounted at the level of the lower aperture 210 of the passage 21 and on which the antenna 2 is mounted by means of elements for fixing and/or suspension of the antenna 3;
a second leaktightness plate 24 mounted at the level of the upper aperture 212 of the passage 21 which opens out on the platform 25 of the surface vessel; this second leaktightness plate 24 thus ensures a double leaktightness barrier in relation to the platform 25;
a plurality of glands or of plug-socket pairs 26 arranged at the level of each leaktightness plate 23 and 24 to make the passage of each cable 22 leaktight;
an assembly of gaskets 27 and 28 to ensure leaktightness at the level of the joints between the first leaktightness plate and the surface vessel 1 on the one hand, as well as between the dome 20 and the surface vessel 1 on the other hand.

The protective dome thus ensures a dual function. On the one hand, it ensures the protection of the sonar antenna 2. Moreover, it indirectly ensures the leaktightness of the surface vessel 1 itself. Thus, in the absence of the dome and of the leaktightness plate 23, the passage 21 provided in the surface vessel allows water to pass through. The surface vessel therefore cannot be placed in the water as long as the dome 20 is not mounted. Consequently, the assembly comprising the sonar antenna 2, the dome 20, the cables 22 and the leaktightness elements 23, 24, 26, 27, 28 must necessarily be mounted in a dry environment. Moreover, during the mounting of the assembly it is necessary to check the various leaktightness points by implementing specific leaktightness tests, the leaktightness elements being able by construction to fail, this being a complex and lengthy operation, further delaying the placing of the surface vessel in the water.

To mount such a sonar antenna assembly, the elements of the assembly are mounted successively after having brought them to the vicinity of the surface vessel positioned on its line of keel blocks. The antenna 2 and its cables are mounted first by suspending the antenna and positioning the cables in the passage 21, and then the dome is fixed rigidly to the hull for example by bolting. The cables can then be joined up to a power supply source at the level of the platform 25. The clearance available under the surface vessel generally being less than 2 meters, it is furthermore necessary to provide a pit in the bottom of the dock. Before mounting the antenna, the dome is thus prepositioned in the pit so as to be able to be fixed on the hull after suspending the antenna. The acoustically matched liquid can thereafter be injected into the dome. The leaktightness tests are carried out during mounting.

Such mounting is complex and constraining, in particular because it can only be carried out in installations in a dry zone having specific and expensive equipment (dry dock). In particular, it does not make it possible to change the antenna at sea. Thus in case of malfunction, the surface vessel must be brought back to a dry zone in order to access the antenna, repeating all the steps of the mounting method. This results in lengthy immobilization of the surface vessel (movement of the surface vessel, intervention in dry dock with dismantling and mounting of the new antenna in several steps, numerous electrical tests and checking of the leaktightness during mounting). Moreover, such a sonar antenna protective assembly makes it necessary to provide a passage (21) of complex configuration in the surface vessel to receive all the leaktightness elements 23, 24, 26, 27 and 28, thus constituting a significant constraint in the surface vessel construction phase.

Moreover, the leaktightness elements between the interfaces between the antenna, the dome and the surface vessel (26, 27, 28) demand regular monitoring and maintenance related to the criticality in terms of risk of water entry for the surface vessel.

### GENERAL DEFINITION OF THE INVENTION

The invention improves the situation. For this purpose, it proposes an integrated antenna device comprising a protective casing of hydrodynamic shape delimiting an inner cavity and an upper fixing interface suitable for being fixed mechanically on a carrier structure. The device furthermore comprises an antenna housed inside the craft and fixed to the internal wall of the casing at the level of at least one fixing point, an assembly of cables comprising power supply and signals reception cables linked to the sonar antenna. The protective casing is closed in a hermetic manner and traversed in a leaktight manner by the cables.

According to a characteristic, the casing can comprise a lower dome and a closing plate which are joined together in a leaktight manner by means of joining elements.

The dome can have a circular drum shape or a streamlined hydrodynamic shape.

The cavity can comprise a protective liquid in which the sonar antenna bathes, the protective liquid being chosen to ensure the acoustic matching of the antenna.

In particular, the fluid can be a non-ionic fluid. The non-ionic fluid can in particular be an oil.

The protective liquid can be pressurized by applying a chosen setpoint pressure.

According to another characteristic, the protective casing can comprise a pressurizing nozzle, while the protective liquid is pressurized by means of a pressurization pump linked to the pressurizing nozzle by a pressurization pipe.

According to a particular embodiment, the antenna can be a sonar antenna.

The invention furthermore proposes a carrier structure intended to receive the antenna device, the carrier structure being intended to be at least partially immersed, the carrier structure comprising a platform configured to be emerged above a water level and a bottom wall. The carrier structure comprises a chimney passing through the bottom wall of the structure and opening out on the platform, the chimney having a lower aperture at the level of the bottom wall of the structure and an upper aperture above the water level, the chimney having a transverse cross section of chosen dimensions, while the fixing interface of the antenna device is adapted to be fixed on the bottom wall of the structure of the surface vessel at the level of the lower aperture of the chimney, the chimney being configured to allow the passage of the cables leading from the antenna device up to the platform of the carrier structure.

The carrier structure can comprise a matching piece provided at the level of the lower aperture of the chimney hugging the shape of the bottom wall of the structure at the level of the lower aperture of the chimney, the fixing interface of the antenna device being able to be fixed on the matching piece.

The invention furthermore proposes a method of mounting an integrated antenna device on a carrier structure comprising a platform emerged above a water level, a bottom wall and a chimney passing through the bottom wall and opening out on the platform, the chimney having a lower aperture at the level of the bottom wall and an upper aperture above the water level. The method advantageously comprises the following steps:
providing an antenna device comprising a protective casing of hydrodynamic shape delimiting an inner cavity, the device furthermore comprising an antenna housed inside the craft, an assembly of cables comprising power supply and signals reception cables linked to the antenna, the protective casing being closed in a hermetic manner and traversed in a leaktight manner by the cables,
positioning the antenna device in the vicinity of the lower aperture of the chimney;
routing the cables of the antenna device along the chimney up to the platform, and
fixing the antenna device to the bottom wall of the structure.

The method can furthermore comprise the steps consisting in:
providing an upper fixing interface on the integrated antenna device;
providing a conjugate fixing interface mating with the fixing interface of the integrated antenna device on the bottom wall of the carrier structure, at the level of the lower aperture of the chimney,
   the step of positioning the antenna device comprising the step consisting in positioning the antenna device in the vicinity of the fixing interface of the bottom wall of the structure while the fixing step comprises the fixing of the antenna device to the bottom wall of the structure by mechanically joining the fixing interface of the antenna device to the fixing interface provided on the bottom wall of the carrier structure.

The invention thus provides an antenna device integrated into a closed and hermetic protective casing which can be filled with a liquid and placed under pressure. This antenna device can be mounted as a single unit on any structure intended to be immersed such as a marine platform (surface vessel, submarine, etc.) and in any environment (dry, at sea, quayside, etc.) without requiring any specific tooling or any post-mounting leaktightness checking step. The fixing of the device to a naval structure requires only a fixing interface.

Moreover, such a device can be easily dismantled in whatever environment the carrier structure is situated for example to replace the antenna in case of fault (for example at sea). The dismantling of the device does not make it necessary to return the structure to a dry zone and can be performed in a short time, thus limiting the immobilization of the structure.

In particular, mounting on the hull of the surface vessel does not make it necessary to validate the leaktightness of the interface between the antenna device and the hull, thus reducing the resources required for the mounting phase and optimizing the mounting time.

### DESCRIPTION OF THE FIGURES

Other characteristics and advantages of the invention will become apparent with the aid of the description which follows and of the figures of the appended drawings in which:

FIG. 1 is a diagram representing a surface vessel equipped with a conventional dome;

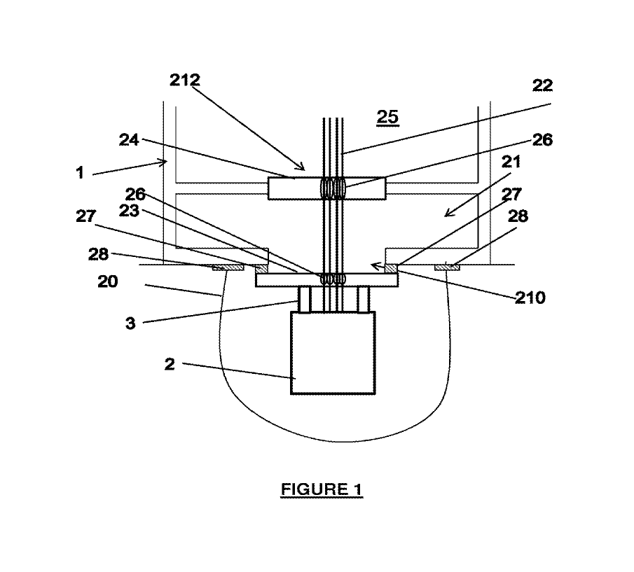

FIG. 2 is a diagram representing a sonar antenna protection device mounted on a carrier structure, according to an exemplary embodiment of the invention;

FIG. 3 is a schematic view of the sonar antenna device according to certain embodiments;

FIG. 4 an exploded view of the sonar antenna device according to certain embodiments;

FIG. 5 is a flowchart representing the method of mounting the sonar antenna device, according to certain embodiments of the invention, and

FIG. 6 is a diagram illustrating the dismantling of the sonar antenna device at sea, according to certain embodiments.

The drawings and the annexes to the description will be able not only to serve for a better understanding of the description, but also to contribute to the definition of the invention, if appropriate.

### DETAILED DESCRIPTION

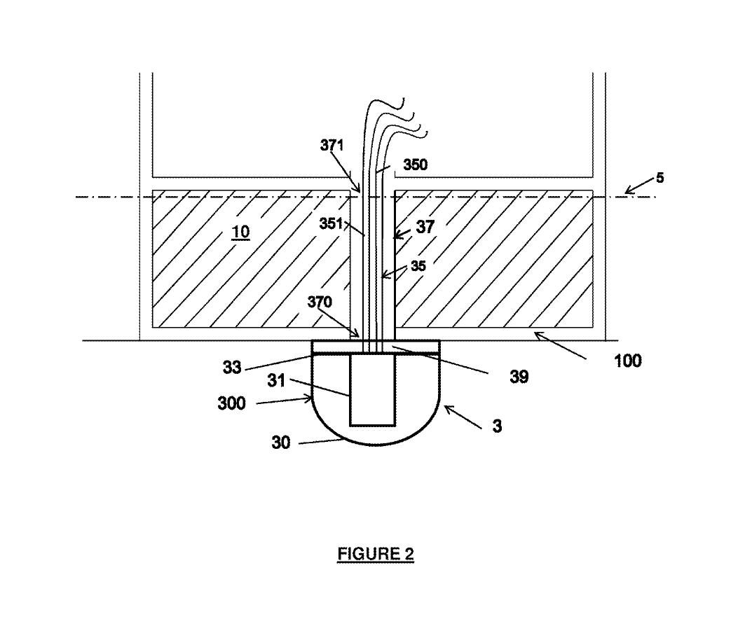

FIG. 2 is a diagram representing an exemplary structure 10 on which an integrated antenna device 3 can be mounted, according to certain embodiments.

The integrated antenna device 3 can be mounted on any fixed or mobile structure 10, intended to be immersed at least partially in the water (for example at sea), such as for example a floating or anchored marine platform or a surface vessel. The structure 10 can in particular comprise a platform emerged above the water level 5 (also called the “water line” hereinafter).

The integrated antenna device 3 comprises a protective casing 300 of hydrodynamic shape delimiting an inner cavity and an antenna 31 arranged inside the inner cavity delimited by the casing 300.

The antenna can consist of an assembly of transducers, for example stacked, configured to ensure the reception and/or emission of signals. The base of the antenna can in particular be fixed to the casing 300, on its upper wall. It should be noted that such fixing does not have any leaktightness function in relation to the structure 10. By fixing the antenna 31 directly to the casing 300, the mechanical interface between the antenna 31 and the carrier vessel 10 is dispensed with.

In particular, the antenna 31 can be a sonar antenna. The subsequent description will be given with reference to an antenna of sonar antenna type by way of nonlimiting example (the integrated antenna device 3 will also be referred to hereinafter as “integrated sonar antenna”).

The shape of the casing 300 can be chosen so as to optimize the navigation of the carrier structure and can in particular be streamlined.

The integrated antenna device 3 can be fixed on the bottom 100 of the structure 10 at the level of the upper wall 33 of the casing 300. The subsequent description will be given with reference to a structure 10 of surface vessel type by way of illustration.

The casing 300 can comprise, on its upper part, a fixing interface intended to be fixed on the hull 100 of the surface vessel 10.

The casing 300 can comprise a dome 30 of hydrodynamic shape, made as one or more pieces and a closing plate 33 joined to the dome in a leaktight manner. For example, the casing can have an open hull shape whose wall is made as a single piece. The closing plate 33 thus forms the upper wall of the casing 300 while the dome 30 delimits the outline of the inner cavity which houses the sonar antenna 31.

The dome 30 can be made from a material which is mechanically very strong and acoustically transparent, in the band of frequencies used, such as for example a glass fiber composite.

As shown in FIG. 2, the integrated sonar antenna device 3 is mounted as a single unit on the hull 100 of a surface vessel 10. The integrated sonar antenna device 3 can thus be mounted on the hull 100 by means of a single fixing interface provided on the topside of the casing 300, thus avoiding having to fix the antenna separately on the surface vessel.

Mounting the antenna 31 directly in the casing 300 thus makes it possible to dispense with an interface with the carrier structure with respect to the conventional implementations.

The sonar antenna 31 can be a passive or active antenna mounted on a support. The sonar antenna 31 may be for example a cylindrical antenna formed of columns of transducers and mounted on the support. The transducers can ensure the emission and/or reception of acoustic signals.

The integrated sonar antenna device 3 can comprise in particular an assembly of cables 35 including power supply cables 350 linked to the antenna 31. The power supply cables are configured to be joined up to one or more power supply sources provided on the platform of the surface vessel 10 above its water line so as to power the antenna 30.

The integrated sonar antenna device 3 is designed to allow the leaktight passage of the cables 35 out of the device. The closing plate 33 can thus be traversed in a leaktight manner by the cables 350 by means of a gland or of plug-socket pairs provided in the closing plate for the passage of each cable.

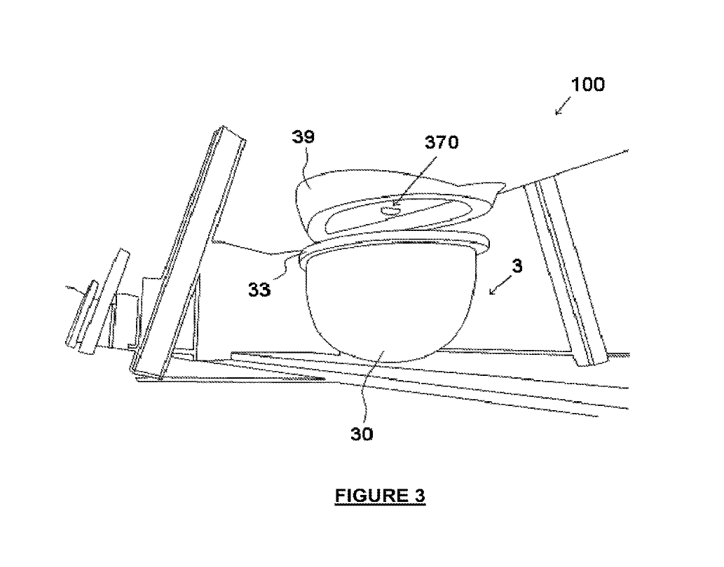

As represented in FIG. 3, the carrier structure 10 can comprise a chimney 37 passing through the hull 100 up to the platform of the structure above the water line so as to allow the passage of the cables 35 from the integrated sonar antenna device 3 to the water line. The chimney 37 passes through the bottom wall of the structure 10 and opens out on the emerged platform. The chimney 37 can thus comprise a lower aperture 370 at the level of the bottom wall and an upper aperture 371 above the water level 5. In particular, the chimney 37 can have a cross section of very small dimensions with respect to the dimensions of the transverse cross section of the casing 300 on its upper part. For example, the cross section of the chimney 37 can have dimensions of the order of just a few centimeters. The length of the chimney 37 depends on the position of the water line of the surface vessel. It can be chosen in particular in such a way as to make the cables 35 open out above the water line. It should be noted that alternative embodiments, the cables 35 can be connected to a connector situated outside the chimney 37 under the water line. Such connectors are then configured for under-water joining and the chimney 37 comprises a cable outlet to such a connector. The subsequent description will be given with reference to a chimney delimiting a cable outlet above the water line by way of nonlimiting example.

The chimney 37 can be in particular configured to rise up sufficiently above the flotation line of the carrier structure 10 and allow the use of a simple chimney closing device.

The chimney 37 can be integrated directly into the carrier structure 10 by construction or form a separate element integrated into the carrier structure at any moment.

The structure of the chimney 37 is thus not very bulky and of simple construction. The integrated sonar antenna device 3 thus reduces the constraints necessary for the interface with the surface vessel.

As a supplement, a matching piece 39 can be fixed between the antenna device 3 and the hull 100 of the surface vessel 30 at the level of the lower end of the chimney 37 so as to match the antenna device 3 to the shape of the hull 100. The matching piece 39 can be fixed beforehand on the hull 100 of the surface vessel 10 before mounting the integrated sonar antenna device 3 on the surface vessel or be fixed on the end of the chimney 37 by construction. The integrated sonar antenna device 3 can thus be joined up to the hull of the surface vessel at the level of the matching piece 39 by using a suitably adapted mechanical clasping system between the matching piece and the closing plate 33, such as for example a mechanical clasping system not requiring any bolting elements.

As shown in FIG. 3, the matching piece 39 comprises an upper face hugging the exterior shape of the hull 100 of the surface vessel and a lower face suited to the shape of the upper part of the casing 300 of the integrated sonar antenna device 3. In particular, the shape of the lower face of the matching plate 39 can be substantially plane. Moreover, the matching piece 39 exhibits an aperture to allow the passage of the cables 35 in the aperture 370. In the example of FIG. 3, the matching piece 39 exhibits a generally elliptical cross section.

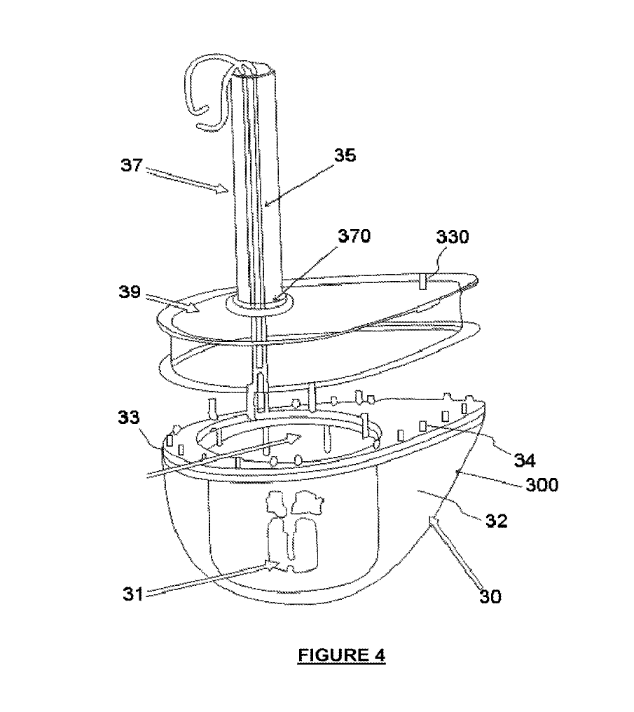

FIG. 4 is an exploded view of the integrated sonar antenna device 3 and of the interface elements between the device 3 and the surface vessel 10. In FIG. 4, the hull 100 of the surface vessel 10 is not illustrated so as to simplify the representation.

In particular, FIG. 4 illustrates the small dimensions of the cross section of the chimney 37 with respect to the antenna device 3. The antenna 31 is represented in transparency in the hollow of the dome 30.

In the example of FIG. 4, the matching piece 39 (socket) has a cross section of similar shape to the cross section of the casing 300. The closing plate 33 can be joined up to the matching piece 39, previously fixed on the hull, by means of mechanical fixing elements 34. The fixing elements 34 between the antenna device 3 and the matching piece 39 can be of any type, such as for example mating latching elements or a clasping device suitable for ensuring fast and effective clasping between the hull 100 and the integrated sonar antenna device 3 (for example by snap-fastening).

In a particular embodiment, the fixing elements 34 can be made in the form of a connector provided on the lower end of the chimney and configured to connect to a mating connector provided on the fixing interface of the casing 300, the connection being able to be mechanical and/or electrical with the cables 35. Such a system of connectors can thus ensure the mechanical and electrical joining of the casing. In particular, such a connector can be adapted for the implementation of under-water joining. Such a connector also makes it possible to prevent water from rising up in the chimney 37 (leaktightness function); It also makes it possible to join up the cables, without it being necessary to raise the cables 35 in the chimney.

The integrated sonar antenna device thus forms an all-in-one hermetic unit including the sonar antenna and its protective dome 30. Such a unit can be mounted and dismantled on the hull 100 of the surface vessel rapidly, without it being necessary to schedule a significant preparation time, with a very simple tooling.

The integrated sonar antenna device 3 can be operational rapidly by fixing it on the hull of the surface vessel 10 at the level of the single fixing interface.

The integrated sonar antenna device 3 can be pre-filled with a protective liquid 32 in which the antenna 31 bathes so as to limit the cavitation effects. As a variant, the antenna device 3 can be filled with the protective liquid after mounting. In such a variant, a second pipe (evacuation pipe) can be used to evacuate the air. Such a liquid makes it possible to ensure the acoustic matching of the antenna while exhibiting a low absorption. The liquid can be water or a non-ionic liquid, oil for example. The closed and hermetic casing 300 makes it possible to choose the fluid so as to optimize the operation and the lifetime of the array of emission and reception sensors (transducers) of the sonar antenna 31, this not being possible with conventional solutions.

In an exemplary embodiment, the protective liquid 32 can be a non-ionic filling fluid, such as an oil. Indeed, the integrated mounting of the dome 30 and of the antenna 31 as a leaktight all-in-one assembly makes it possible to pre-fill the casing with oil, without it being necessary to carry out the casing filling operation in dry dock and once the dome has been installed.

The use of oil as dome filling liquid exhibits several other advantages. It eliminates the problems of corrosion, greatly limits the cavitation phenomena, and makes it possible to immerse the electro-acoustic or magneto-acoustic or optico-acoustic transduction elements of the antenna 31 (piezoelectric sensors for example), the electronic cards and the points of connection facilities internal to the acoustic base of the antenna without it being necessary to provide additional electrical insulation protection. Its density can be chosen so as to obtain a chosen buoyancy level of the antenna device 3 assembly, such as for example a substantially neutral buoyancy level.

According to another characteristic, a setpoint pressure can be applied to the acoustic base of the sonar antenna 31 to pressurize the fluid. Pressurization makes it possible in particular:
to optimize the operation of the array of emission and reception sensors, for example in relation to the effects of acoustic cavitation, and/or
to optimize the resilience of the acoustic base to mechanical constraints exerted on the casing 300 in relation to certain mechanical loadings related to the operation of the carrier structure 10, such as for example the effects of external overpressure due to the slamming when the device is used on a structure of surface vessel type, or to immersion, when the device is used on a structure of variable-immersion vehicle or fish type; the dome 30 and the closing plate 33 can have a thickness chosen accordingly.

In particular, the closed and hermetic casing 300 makes it possible to apply such a setpoint pressure by inflation.

Therefore the casing can exhibit a pressurizing nozzle 330. Moreover, the cable assembly 35 can furthermore include a pressurization pipe 351 linked to the pressurizing nozzle 330 provided on the topside of the casing, away from the fixing interface.

The pressurizing nozzle can thus be used to pressurize, and in particular over-pressurize, the protective liquid 32 in which the integrated sonar antenna device 3 bathes and prevent the possible re-entry of water. Advantageously, the pressurization can be carried out after mounting the antenna device 3 by means of a pressurization pump provided on the platform of the surface vessel 10, above the water line. An operator can link the pressurization pump to the pressurizing nozzle 330 via the pressurization pipe 351, after mounting the integrated sonar antenna device 3 and passing the cables through the chimney 37. The pressurization pipe 351 is connected to the antenna device 3 before presenting it on the carrier structure 10, and before being threaded through the chimney 37 just as for the other cables 35. This then remains compatible with a chimney of small diameter). The casing 300 can then be inflated under pressure by actuating the pressurization pump connected to the pressurizing nozzle via the cable 351. The closed and hermetic casing 300 of the integrated sonar device thus makes it possible to apply a setpoint pressure to the acoustic base of the sonar antenna 31 by inflation. The setpoint pressure can be chosen in particular so as to over-pressurize the casing.

As a supplement, the casing 300 can comprise other pressurization elements such as a device for compensating the thermal expansion of the filling fluid.

In certain embodiments, the pressurization pipe 351 can also be used to fill the fluid casing 300 (oil for example). An air evacuation pipe, similar to the pressurization pipe 351, can then be provided.

Such an integrated sonar antenna device 3 offers the advantage of being mountable on the surface vessel, in any environment, whether at sea, in the factory, or in dry dock.

The leaktightness of the integrated sonar antenna device 3 can be tested well before it is mounted on the carrier structure 10 and independently of the latter. Moreover, it does not require regular checking subsequently, thus simplifying the maintenance of the integrated sonar antenna device 3 after it is mounted on the carrier structure. The necessary leaktightness points related to the mounting of the integrated sonar antenna device 3 are also greatly reduced. It is no longer necessary to provide for a second level of leaktightness on the upper part of the surface vessel by means of an additional leaktightness plate, or of glands or of an assembly of plug—socket pairs in the chimney to make the passage of the cables leaktight. Moreover, a leaktight integrated sonar antenna device 3 such as this which integrates the sonar antenna and the protective casing 300 into a single unit simplifies the construction of the surface vessel. Indeed, the chimney 37 can be obtained through a simple pipe of small diameter ensuring the passage of the cables without further impact on the construction of the complex structure. In particular, the chimney 37 can be easily protected against the rising of the water in the absence of the antenna device 3 by mounting a “stopper” plate in the lower aperture 370 of the chimney 37. Such a stopper plate is configured to prevent a surge of water rising up in the chimney and ensure protection against breaker waves, thus allowing the surface vessel to put to sea before mounting the device 3.

In particular, the integrated sonar antenna device 3 can be mounted in any environment (dry zone or at sea) without specific rigging or complex installation. When the antenna device 3 is mounted in dry dock, it is not necessary to provide a pit to supplement the clearance present under by the hull of the surface vessel. Indeed, the antenna device 3 being mounted as a single unit, a small clearance of 1 or 2 meters is sufficient to carry out the mounting operation.

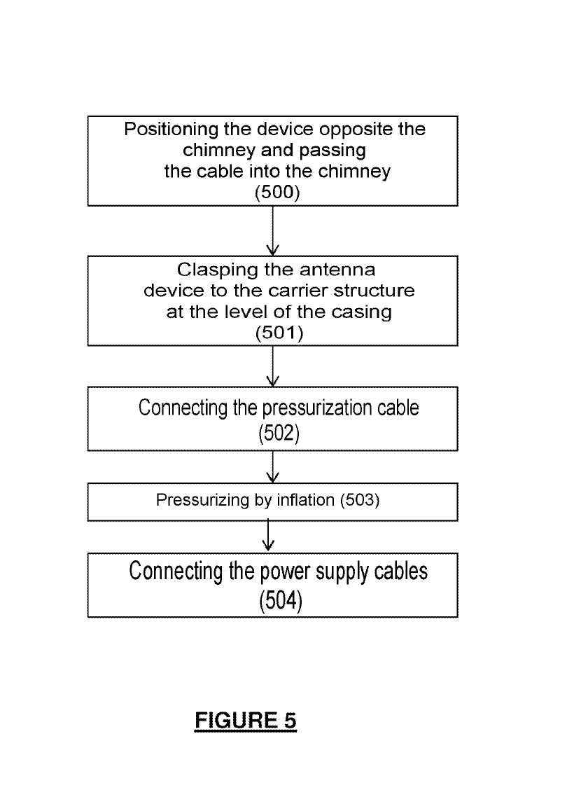

FIG. 5 represents the method of mounting the device for example quayside or dry.

In step 500, the sonar antenna device 3 is brought as a single pre-assembled unit in proximity to the hull of the surface vessel 10, facing the chimney 37, for example by means of a rolling support such as a pallet truck in the embodiments where mounting is carried out on a carrier structure 10 in the dry state.

In particular, in the embodiment where mounting is carried out on a surface vessel 10 at the quayside, the hull then being immersed, it is possible to use a pallet truck to bring the dome close to the boat, and then a crane to place the sonar antenna device in the water after having equipped it with floats. Divers can then bring it to face the chimney 37.

The antenna device 3 can be pre-filled with the acoustically matched liquid 32 (oil or water for example). The cables 35 of the device 3 can previously be wound on a strand and then positioned and raised in the chimney 37 through the aperture 370 by using a device of “cable puller” type to thread the cable strand 35 in the chimney.

In step 501, the integrated sonar antenna device 3 is fixed to the matching piece 39, previously mounted on the hull at the level of the lower aperture 370 of the chimney 37, for example by clasping, using the joining means 34.

In step 502, the pressurization pipe 351 is connected to the pressurization pump.

In step 503, the casing 300 is pressurized by inflation.

In step 504, the cables 35 can be joined up to the power supply source by the operator.

The integrated sonar antenna device 3 thus forms an all in one system, requiring a much reduced mounting time relative to the solutions of the prior art. Moreover, it requires a minimal interface with the hull 100 of the surface vessel 10. Pressurization by inflation greatly simplifies the method of pressurization without it being necessary to provide for a complex pressurization system on the platform of the surface vessel (above the water line). Such a method of mounting does not include any leaktightness checking step to check the leaktightness of the platform and/or of the integrated sonar antenna device 3.

Moreover, the method of mounting can be implemented without it being necessary to provide for a significant preparation time.

According to another characteristic of the invention, the integrated sonar antenna device 3 can be changed at any moment and in any suitable environment, such as quayside, in dry dock or at sea, for example in case of fault with the antenna. The length of the cables 35 can be chosen to allow the dismantling of the antenna device 3 without it being necessary to pull the cables back out of the chimney 37.

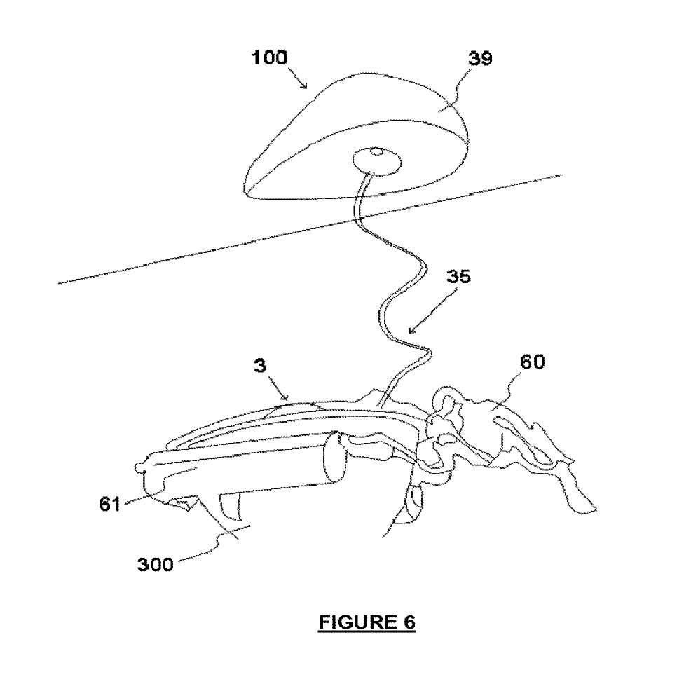

FIG. 6 illustrates an example of dismantling the antenna device 3 at sea. The integrated sonar antenna device 3 can be dismantled as a single unit by a diver 60 equipped with floating supports 61 (for example adjustable flotation cradle or supports made of foam). The over-length of the cables makes it possible to release the integrated sonar antenna device 3 and move it toward a platform in proximity so as to replace the sonar antenna 3, repair it or replace the assembly of the device 3. The integrated sonar antenna device 3 can then be replaced at the quayside for example in a port or a shelter, while the surface vessel 10 remains in the water.

Thus, when replacing the antenna 31, the integrated sonar antenna device 3 can be dismantled rapidly and effectively with small tooling elements (floating supports). The immobilization of the antenna device 3 at the quayside can be greatly reduced. Continuity of operational capacity of the device 3 can be thus be ensured.

The invention is not limited to the embodiments described hereinabove by way of nonlimiting example. It encompasses all the variant embodiments that could be envisaged by the person skilled in the art. In particular, the invention is not limited to a particular type of sonar antenna or to a dome having a hull shape. Moreover, neither is the invention limited to a particular fixing interface between the integrated sonar antenna device 3 and the hull 100 of the surface vessel. Furthermore the invention is not limited to a carrier structure furnished with a chimney 37. Indeed, the integrated antenna device 3 can be mounted on a carrier structure provided with some other type of leaktightness system.

1. An integrated antenna device, comprising a protective casing of hydrodynamic shape delimiting an inner cavity and an upper fixing interface suitable for being fixed mechanically on a carrier structure, the device further comprising an antenna housed inside the inner cavity and fixed to the internal wall of the casing at the level of at least one fixing point, an assembly of cables comprising power supply and signals reception cables linked to the antenna, and wherein the protective casing is closed in a hermetic manner and traversed in a leaktight manner by said cables.

2. The integrated antenna device as claimed in claim 1, wherein the casing comprises a lower dome and a closing plate which are joined together in a leaktight manner.

3. The integrated antenna device as claimed in claim 2, wherein the dome has a circular drum shape or a streamlined hydrodynamic shape.

4. The integrated antenna device as claimed in claim 1, wherein the cavity comprises a protective liquid in which the antenna bathes, said protective liquid being chosen to ensure the acoustic matching of the antenna.

5. The integrated antenna device as claimed in claim 4, wherein the protective liquid is a non-ionic fluid.

6. The integrated antenna device as claimed in claim 5, wherein the non-ionic fluid is an oil.

7. The integrated antenna device as claimed in claim 4, wherein the protective liquid is pressurized by applying a chosen setpoint pressure.

8. The integrated antenna device as claimed in claim 7, wherein the protective casing comprises a pressurizing nozzle, and wherein the protective liquid is pressurized by means of a pressurization pump linked to the pressurizing nozzle by a pressurization pipe.

9. The integrated antenna device as claimed in claim 1, wherein the antenna is a sonar antenna.

10. A carrier structure intended to receive said antenna device as claimed in claim 1, the carrier structure being intended to be at least partially immersed, the carrier structure comprising a platform configured to be emerged above a water level and a bottom wall, comprising a chimney passing through the bottom wall of the structure and opening out on the platform, the chimney having a lower aperture at the level of the bottom wall of the structure and an upper aperture above the water level, the chimney having a transverse cross section of chosen dimensions, and wherein the fixing interface of said antenna device is adapted to be fixed on the bottom wall of the structure of the surface vessel at the level of the lower aperture of the chimney, the chimney being configured to allow the passage of the cables leading from the antenna device to the platform of the carrier structure.

11. The carrier structure as claimed in claim 10, comprising a matching piece provided at the level of the lower aperture of the chimney and hugging the shape of the bottom wall of the structure at the level of the lower aperture of the chimney, the fixing interface of the antenna device being able to be fixed on the matching piece.

12. A method of mounting an integrated antenna device on a carrier structure comprising a platform emerged above a water level, a bottom wall and a chimney passing through the bottom wall and opening out on the platform, the chimney having a lower aperture at the level of the bottom wall and an upper aperture above the water level, comprising the following steps:
providing an antenna device comprising a protective casing of hydrodynamic shape delimiting an inner cavity, the device further comprising an antenna housed inside the inner cavity, an assembly of cables comprising power supply and signals reception cables linked to the antenna, the protective casing being closed in a hermetic manner and traversed in a leaktight manner by said cables.
positioning the antenna device in the vicinity of the lower aperture of the chimney;
routing the cables of the antenna device along the chimney up to the platform, and
fixing the antenna device to the bottom wall of the structure.

13. The method of mounting as claimed in claim 12, further comprising the steps of:
providing an upper fixing interface on the integrated antenna device;
providing a conjugate fixing interface mating with the fixing interface of the integrated antenna device on the bottom wall of the carrier structure, at the level of the lower aperture of the chimney,
and wherein the step of positioning the antenna device comprises the step consisting in positioning the antenna device in the vicinity of the fixing interface of the bottom wall of the structure while the fixing step comprises the fixing of the antenna device to the bottom wall of the structure by mechanically joining the fixing interface of the antenna device to the fixing interface provided on the bottom wall of the carrier structure.
